(19) United States
(12) Patent Application Publication
(10) Pub. No.: US 2019/0087916 A1
(43) Pub. Date: Mar. 21, 2019

(54) MODEL-BASED RECOMMENDATION OF CAREER PATH TRANSITIONS IN SOCIAL NETWORKS

(71) Applicant: LinkedIn Corporation, Sunnyvale, CA (US)

(72) Inventors: Qin Iris Wang, Cupertino, CA (US); Bryan S. Hsueh, Fremont, CA (US); Ningfeng Liang, Cupertino, CA (US); Mahesh Vishwanath, Cupertino, CA (US); Paul Ogden Fletcher, Sunnyvale, CA (US); Angela J. Jiang, San Mateo, CA (US); Shubham Anandani, Sunnyvale, CA (US); Warren E. Bartolome, San Jose, CA (US); Aayush Gopal Dawra, San Francisco, CA (US); Bef Ayenew, Fremont, CA (US); Charu Jangid, San Francisco, CA (US)

(73) Assignee: Microsoft Technology Licensing, LLC, Redmond, WA (US)

(21) Appl. No.: 15/721,014

(22) Filed: Sep. 29, 2017

Related U.S. Application Data
(60) Provisional application No. 62/561,551, filed on Sep. 21, 2017.

(51) Int. Cl. G06Q 50/00; G06Q 10/10

(52) U.S. Cl. CPC G06Q 50/01; G06Q 10/1053

(57) ABSTRACT

The disclosed embodiments provide a system for improving use of a social network. During operation, the system obtains job histories for members of the social network. Next, the system aggregates a set of job transitions in the job histories to obtain a set of job transition trends associated with the members. The system then matches a job transition trend in the set of job transition trends to member features for a member of the social network. Finally, the system outputs the job transition trend as a recommendation for advancing a career of the member.

### RELATED APPLICATION

This application claims priority under 35 U.S.C. section 119(e) to U.S. Provisional Application Ser. No. 62/561,551, entitled “Model-Based Recommendation of Career Path Transitions in Social Networks,” by inventors Qin Iris Wang, Bryan S. Hsueh, Ningfeng Liang, Mahesh Vishwanath, Paul Ogden Fletcher, Angela J. Jiang, Shubham Anandani, Warren E. Bartolome, Aayush Gopal Dawra, Bef Ayenew and Charu Jangid, filed on 21 Sep. 2017.

### BACKGROUND

### Field

The disclosed embodiments relate to user recommendations. More specifically, the disclosed embodiments relate to techniques for performing model-based recommendation of career path transitions in social networks.

### RELATED ART

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate activities related to business, sales, recruiting, networking, professional growth, and/or career development. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for improving use of a social network in accordance with the disclosed embodiments.

FIG. 3 shows the recommendation of job transition trends in a social network in accordance with the disclosed embodiments.

FIG. 4 shows a flowchart illustrating a process of recommending a job transition trend in a social network in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

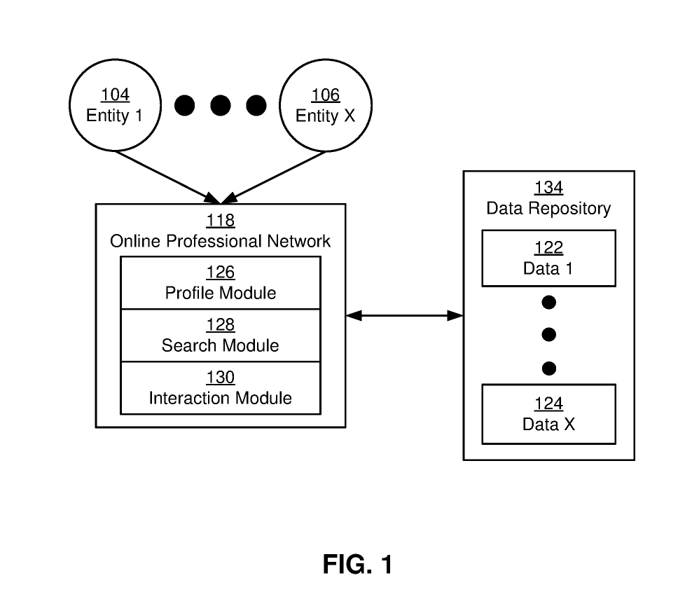

The disclosed embodiments provide a method, apparatus, and system for improving use of a social network or another community of users. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience. As described in further detail below, such suggestions may improve the quality and completeness of the profiles, as well as the functionality of online professional network 118 for the entities.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

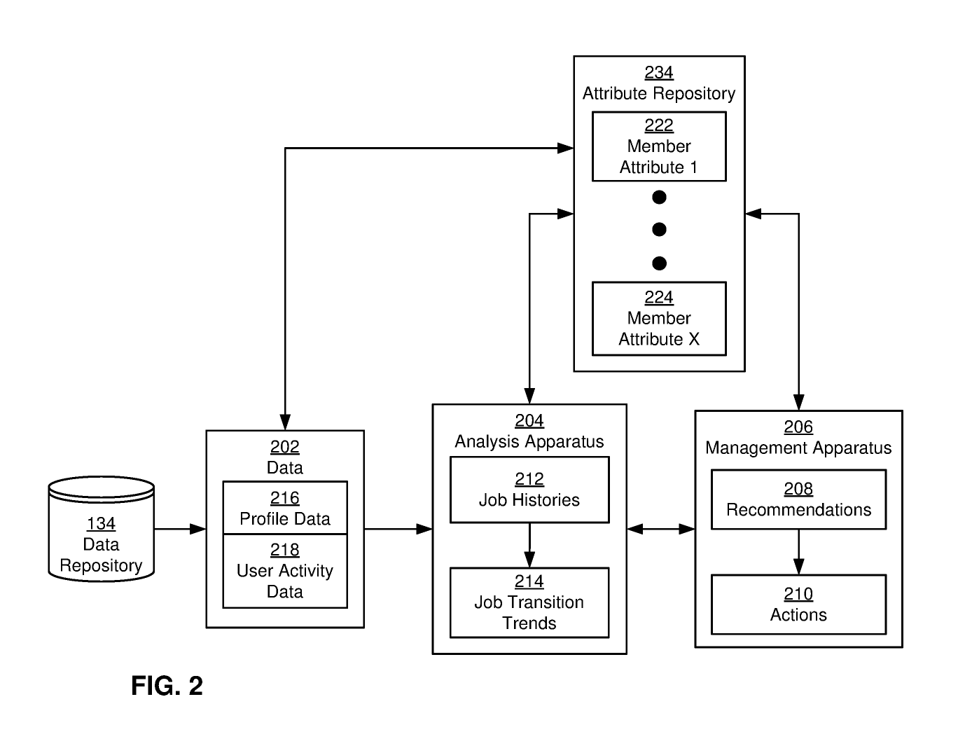

As shown in FIG. 2, data repository 134 and/or another primary data store may be queried for data 202 that includes profile data 216 for members of a social network (e.g., online professional network 118 of FIG. 1), as well as user activity data 218 that tracks the members' activity within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of member interactions with one another and/or content associated with the social network. For example, user activity data 218 may be used to track impressions, clicks, likes, dislikes, shares, hides, comments, posts, updates, conversions, and/or other user interaction with content in the social network. User activity data 218 may also track other types of activity, including connections, messages, and/or interaction with groups or events. Like profile data 216, user activity data 218 may be used to create a graph, with nodes in the graph representing social network members and/or content and edges between pairs of nodes indicating actions taken by members, such as creating or sharing articles or posts, sending messages, connection requests, joining groups, and/or following other entities.

In one or more embodiments, profile data 216 and user activity data 218 are used to improve the recommendation and/or use of member attributes (e.g., member attribute 1 222, member attribute x 224) found in member profiles of the members. The member attributes may include values of location, skills, titles, industries, companies, schools, summaries, publications, patents, and/or other fields in the member profiles. The member attributes may be extracted from profile data 216 in data repository 134 and/or an attribute repository 234 containing standardized member attributes.

Attribute repository 234 may store data that is used to standardize, organize, and/or classify member attributes in profile data 216. For example, skills in profile data 216 may be organized into a hierarchical taxonomy that is stored in attribute repository 234 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

As mentioned above, a profile module (e.g., profile module 126 of FIG. 1) in the social network may include functionality to recommend or suggest profile edits to the member's profiles. More specifically, a management apparatus 206 may generate a set of recommendations 208, with each recommendation containing one or more member attributes from attribute repository 234 that are determined to be relevant to the member profile of a given member. For example, management apparatus 206 may generate recommendations 208 based on existing fields in the member profile, relationships among member attributes in the taxonomy, the presence of the member attributes in member profiles of similar members and/or the member's connections, publicly available data, and/or other types of data or inference.

Management apparatus 206 and/or another component may display recommendations 208 within a graphical user interface (GUI) and/or application (e.g., web application, mobile application, native application, etc.) for accessing the social network. For example, recommendations 208 may be displayed within a content feed, profile-completion feature, recommendation feature, search feature, and/or another feature associated with the social network. Recommendations 208 may also, or instead, be delivered via email, a messaging service, one or more notifications, and/or another mechanism for communicating or interacting with the member.

Management apparatus 206 may also track actions 210 taken by the members in response to recommendations 208. For example, each member may have the option of performing an action in the recommendation (e.g., adding a recommended member attribute, viewing supplemental information or pages related to the recommendation, connecting with other members to obtain assistance associated with the recommendation, etc.) and/or ignoring the recommendation. Each response may be stored with an identifier of the corresponding member, an identifier of the recommendation to which the response was made, identifiers of one or more recommended member attributes in the recommendation, a timestamp of the response, and/or the action taken in the response.

An analysis apparatus 204 may aggregate job histories 212 from profile data 216 and/or user activity data 218 to obtain a number of job transition trends 214 associated with the members. For example, each job history may include a chronological sequence of jobs for a given member that terminates in the member's current job and/or the member's most recently listed job. As a result, the job history may be assembled from current and/or previous jobs listed in the member's current profile data 216 and/or user activity data 218 containing updates to jobs in the member's profile over time. Jobs in the job history may also be updated to include standardized titles, industries, seniorities, and/or other attributes from attribute repository 234.

In particular, analysis apparatus 204 may aggregate job histories 212 from multiple members of the social network by job-related attributes to identify job transition trends 214 as the most frequent and/or common types of job transitions among the members. For example, analysis apparatus 204 may use job histories 212 to identify job transition trends 214 between companies, company sizes, industries, job titles, seniorities, locations, and/or other job-related attributes. In another example, analysis apparatus 204 may apply a statistical model to job histories 212 to predict, based on a member's current job, job history, education, skills, and/or other member attributes, the most likely company, company size, title, industry, and/or seniority associated with the member's next job.

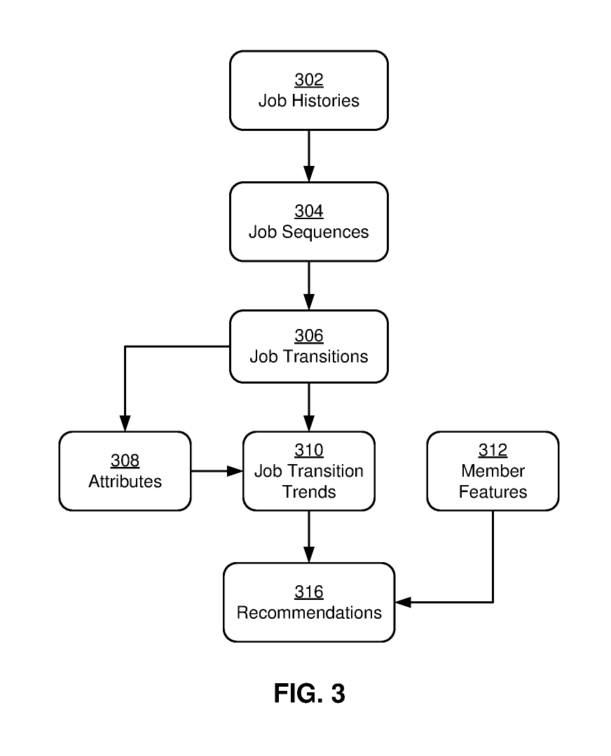

Job transition trends 214 may then be used by analysis apparatus 204 and/or management apparatus 206 to generate and/or improve recommendations 208. For example, analysis apparatus 204 may match a current job and/or most recently listed job of a member to a job transition trend of moving from the current job to a new job with a different title, industry, company, company size, and/or seniority. In turn, management apparatus 206 may output the job transition trend in a recommendation for advancing the career of the member, thereby increasing the relevance or usefulness of the social network to the member. Using job transitions to identify job transition trends and generate recommendations based on the job transition trends is described in further detail below with respect to FIG. 3.

By generating recommendations 208 associated with job transition trends 214, the system of FIG. 2 leverages social networks and profile data in social networks to provide insights that facilitate career advancement for members of the social network. For example, the system may suggest subsequent roles for the members and/or steps of qualifications required in the subsequent roles, thereby providing career guidance for the members. In turn, the system may increase the value of the social network to the members, the value provided by the members to the social network, and/or member engagement with the social network. Consequently, the system may improve technologies related to use of online social networks through network-enabled devices and/or applications, as well as user engagement and interaction through the social networks, network-enabled devices, and/or applications.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of techniques may be used to identify job transition trends 214 from job histories 212 and/or other data 202 in data repository 134. As mentioned above, a statistical model may be used to predict one or more attributes of a member's next job or jobs based on the member's current job, previous jobs, background, skills, education, and/or other member attributes. The statistical model may include a regression model, artificial neural network, support vector machine, decision tree, random forest, gradient boosting tree, naïve Bayes classifier, Bayesian network, clustering technique, deep learning model, hierarchical model, and/or ensemble model. Alternatively, job histories 212 may be aggregated into one or more summary statistics (e.g., counts, means, medians, percentiles, etc.) that are used to identify job transition trends 214.

Third, profile data 216, user activity data 218, job histories 212, and/or other data used to identify job transition trends 214 and/or generate recommendations 208 may be obtained from a variety of sources. As mentioned above, the data may be obtained and/or tracked within a social network and/or other community of users. Alternatively, some or all of the data may be obtained from other applications, user interactions, and/or public records.

FIG. 3 shows the recommendation of job transition trends 310 in a social network in accordance with the disclosed embodiments. As mentioned above, job transition trends 310 may be obtained from job histories 302 of members of the social network. Job histories 302 may include job sequences 304 associated with the members, with each job sequence containing a chronological list of jobs for a given member. For example, a member's job sequence may include jobs and/or positions occupied by the member that are ordered by start and/or end date.

Job transitions 306 may then be obtained as temporally ordered pairs of consecutive jobs from job sequences 304. For example, a job sequence containing four jobs may include three job transitions 306 between the first and second jobs, the second and third jobs, and the third and fourth jobs. Each job transition may include attributes 308 related to a first job from which a member has transitioned and a second, subsequent job to which the member has transitioned. For example, attributes 308 may identify the industry of the member, the first job, and/or the second job. Attributes 308 may also include the companies, company sizes, titles, seniorities, and/or locations of the first and second jobs.

Job transitions 306 may also, or instead, include non-consecutive jobs in job sequences 304 that include common and/or related attributes 308. For example, a job sequence may include two paid positions in the same company and/or industry, which are separated by an unpaid volunteer position that overlaps in time with one or both paid positions and is with a different company and/or industry. As a result, the job sequence may produce a job transition between the two paid positions because the paid positions are more likely to be related to the career path of the corresponding member than the unpaid position.

Job transitions 306 may then be aggregated by attributes 308 associated with the corresponding pairs of jobs to obtain job transition trends 310. For example, job transitions 306 may be aggregated by member industry, the title of the first job, and the title of the second job to identify trends in job transitions 306 between titles for a given industry. In a second example, job transitions 306 may be aggregated by company and/or member industry, the company of the first job, and the company of the second job to identify trends in job transitions 306 between companies for a given industry. In a third example, job transitions 306 may be aggregated by company and/or member industry, the company size of the first job, and the company size of the second job to identify trends in job transitions 306 between company sizes for a given industry. In a fourth example, job transitions 306 may be aggregated by the seniorities of the first and second jobs to identify trends in job transitions 306 between different seniorities. In a fifth example, job transitions 306 may be aggregated by titles, companies, and/or other attributes 308 that exclude industry to identify various job transition trends 310 associated with moving between industries. In a sixth example, job transitions 306 may be aggregated by a first attribute associated with the first job (e.g., industry) and a second, different attribute associated with the second job (e.g., company) to identify patterns in job transitions 306 across different types of attributes 308.

After job transitions 306 are aggregated into counts and/or other summary statistics associated with the corresponding attributes 308, job transition trends 310 may be obtained as the most frequent and/or common job transitions 306 associated with a given aggregation. For example, job transition trends 310 may include a pre-specified number of job transitions 306 with the highest count in a given aggregation and/or across all aggregations. In another example, job transition trends 310 may include aggregated job transitions 306 with counts and/or other summary statistics that are higher than a pre-specified threshold (e.g., percentile, number, etc.).

Once job transition trends 310 are identified, job transition trends 310 are matched to member features 312 of the members. For example, one or more attributes of a member's current and/or former jobs (e.g., title, company, industry, seniority, etc.) may be matched to the corresponding attributes 308 of the first job in a job transition trend.

Alternatively, summary statistics generated from aggregated job transitions 306 may be used as input to a statistical model that predicts, for a given set of member features 302 (e.g., job history, educational background, skills, title, industry, location, demographic attributes, publications, groups, etc.), one or more subsequent jobs for the corresponding member. For example, the statistical model may output an industry, title, seniority, company, company size, and/or other attribute associated with a predicted next job for the member and/or one or more confidence scores associated with the outputted attribute(s).

Job transition trends 310 that are matched to member features 312 of one or more members may then be outputted in one or more recommendations 316 to the member(s). Recommendations 316 may be displayed within a homepage, news feed, search module, profile module, and/or other part of the social network. Recommendations 316 may also, or instead, be delivered via email, a messaging service, one or more notifications, and/or another mechanism for communicating or interacting with the member.

Recommendations 316 may identify one or more attributes 308 associated with the corresponding job transition trends 310. For example, a recommendation may identify one or more member features 312 used to match a member to a job transition trend (e.g., “People with your job title are moving to a new role”). The recommendation may also include attributes 308 associated with one or both jobs in the job transition trend (e.g., the job title, company, company size, industry, seniority, and/or location associated with the first and/or second jobs in the job transition trend).

Recommendations 316 may provide additional information and/or actions to facilitate carrying out of the corresponding job transition trends 310. For example, a recommendation to transition from a member's current job to a new job title and/or company may include a mechanism for searching for, identifying, and/or reaching out to other members who have made the same transition. The other members may be in the member's network (e.g., first- and/or second-degree connections of the member) or outside the member's network (e.g., people who are willing to act as mentors or offer advice on certain career transitions).

In another example, the recommendation may include a statistic associated with the transition (e.g., “192 people transitioned to this role this month,” “people who transitioned to this role have increased their annual salary by an average of $10,000,” etc.). In a third example, the recommendation may suggest a job listing, recruiter, company, and/or other resource that can help the member find a position to complete the transition.

In a fourth example, the recommendation may outline one or more career paths for the member, with each career path containing a sequence of jobs from the member's current job and/or one or more previous jobs to increasingly senior and/or advanced positions. The recommendation may also include suggestions or advice for advancing along the career path, such as skills, education, and/or work experience required to move to subsequent jobs in the career path; companies, recruiters, and/or job listings that can be leveraged to transition to each job in the career path; and/or courses or materials for learning skills and/or acquiring experience required to move to each job in the career path. Consequently, recommendations 316 of job transition trends 310 may be used to provide guidance and/or insights for developing the careers of the members.

Recommendations 316 associated with job transition trends 310 may also, or instead, be given to other entities in the social network. For example, one or more members that are matched to a given job transition trend may be recommended as potential job candidates for companies, recruiters, and/or other entities with job listings that match the job transition trend. The members may further be sorted and/or filtered by skills, education, work experience, and/or other qualifications associated with the job listings.

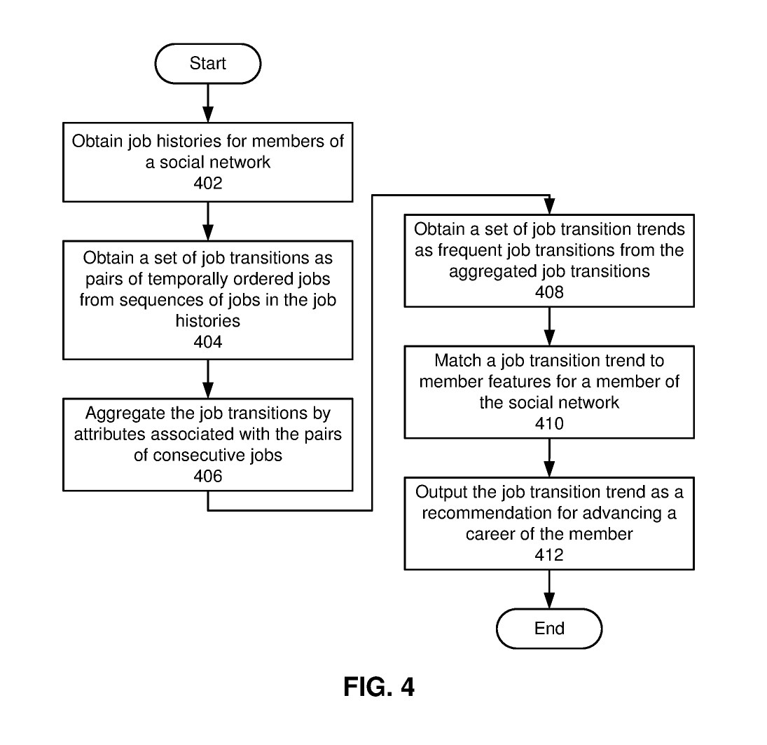

FIG. 4 shows a flowchart illustrating a process of recommending a job transition trend in a social network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, job histories for members of a social network are obtained (operation 402). The job histories may include current and/or previous jobs of the members that are listed in the member's profiles and/or obtained from records of the member's profile updates.

Next, a set of job transitions in the job histories is aggregated to obtain a set of job transition trends associated with the members. In particular, a set of job transitions is obtained as pairs of temporally ordered jobs from sequences of jobs in the job histories (operation 404). For example, a job history for a member may include a chronologically ordered sequence of jobs held by the member, up to the member's current job and/or the most recently listed job for the member. In turn, job transitions for the member may include transitions between consecutive and/or non-consecutive chronologically ordered jobs in the sequence.

The job transitions are then aggregated by attributes associated with the corresponding pairs of consecutive jobs (operation 406), and the job transition trends are obtained as frequent job transitions from the aggregated job transitions (operation 408). For example, the job transitions may be aggregated by companies, company sizes, industries, seniorities, titles, locations, and/or other attributes associated with the first and second jobs in each job transition to obtain a count, mean, median, percentile, and/or other summary statistic associated with the job transitions. The job transition trends may then be obtained as the most frequent and/or common job transitions for each type of aggregation, aggregated job transitions with summary statistics that exceed a given value (e.g., count, percentile, etc.), and/or job transitions that frequently occur within a given member segment (e.g., industry, location, language, etc.). The job transition trends may also, or instead, be obtained using one or more statistical models that are trained using the aggregated job transitions. In turn, the statistical model(s) may predict, for a given set of attributes (e.g., industry, seniority, title, company, company size, location, etc.) associated with a first job, one or more attributes of a second job following the first job.

Multiple types of aggregation may also be performed to identify job transition trends associated with multiple types of attributes. For example, the job transitions may be aggregated by industries and job titles associated with the first and second jobs to determine job transition trends that involve industry changes. In another example, the job transitions may be aggregated by titles and companies associated with the first and second jobs to identify job transition trends associated with changing companies instead of within the same company.

Once the job transition trends are obtained, a job transition trend is matched to member features for a member of the social network (operation 410). For example, the company, company size, industry, title, seniority, location, and/or other attribute associated with the first job in the job transition trend may be matched to the current job, most recently listed job, and/or other profile attributes for the member in the social network.

Finally, the job transition trend is outputted as a recommendation for advancing a career of the member (operation 412). For example, the recommendation may suggest a transition from the member's current job and/or most recently listed job to a second job associated with a job transition trend that is relevant to the member. The recommendation may also include mechanisms for identifying, searching for, and/or reaching out to other members who have made the same transition or a similar transition; job listings, companies, recruiters, and/or other resources that can be used to make the transition; and/or one or more career paths that include the recommended transition, as well as additional transitions to subsequent jobs after the second job. Operations 410-412 may be repeated for additional members of the social network and/or other job transition trends associated with the members.

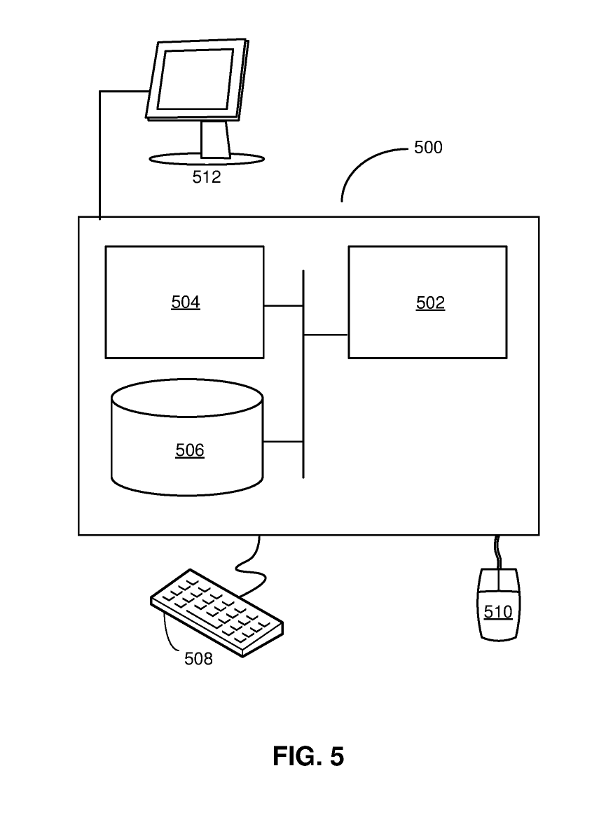

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for improving use of a social network. The system includes an analysis apparatus and a management apparatus, one or both of which may alternatively be termed or implemented as a module, mechanism, or other type of system component. The analysis apparatus may obtain job histories for members of a social network. Next, the analysis apparatus may aggregate a set of job transitions in the job histories to obtain a set of job transition trends associated with the members. The analysis apparatus may then match a job transition trend in the set of job transition trends to member features for a member of the social network. Finally, the management apparatus may output the job transition trend as a recommendation for advancing a career of the member.

In addition, one or more components of computer system 500 may be remotely located and connected to the other components over a network. Portions of the present embodiments (e.g., analysis apparatus, management apparatus, data repository, attribute repository, etc.) may also be located on different nodes of a distributed system that implements the embodiments. For example, the present embodiments may be implemented using a cloud computing system that recommends job and/or career path transitions for advancing the careers of a set of remote members of a social network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining job histories for members of a social network;
aggregating, by a computer system, a set of job transitions in the job histories to obtain a set of job transition trends associated with the members;
matching, by the computer system, a job transition trend in the set of job transition trends to member features for a member of the social network; and
outputting the job transition trend as a recommendation for advancing a career of the member.

2. The method of claim 1, wherein aggregating the set of job transitions in the job histories to obtain the set of job transition trends associated with the members comprises:
obtaining the set of job transitions as pairs of chronologically ordered jobs from sequences of jobs in the job histories;
aggregating the job transitions by attributes associated with the pairs of jobs; and
obtaining the set of job transition trends as a set of most frequent job transitions from the aggregated job transitions.

3. The method of claim 2, wherein the attributes comprise a first company associated with a first job and a second company associated with a second job.

4. The method of claim 2, wherein the attributes comprise a first industry associated with a first job and a second industry associated with a second job.

5. The method of claim 2, wherein the attributes comprise a first company size associated with a first job and a second company size associated with a second job.

6. The method of claim 2, wherein the attributes comprise a first title associated with a first job and a second title associated with a second job.

7. The method of claim 2, wherein the attributes comprise a first seniority associated with a first job and a second seniority associated with a second job.

8. The method of claim 1, wherein matching the job transition trend to the member features for the member comprises:
matching an attribute of a job in the member features to a first job in the job transition trend.

9. The method of claim 1, wherein outputting the job transition trend as the recommendation for advancing the career of the member comprises:
recommending a transition from a current job of the member to a second job in the job transition trend.

10. The method of claim 9, wherein outputting the job transition trend as the recommendation for advancing the career of the member further comprises:
identifying an additional member who has made the transition from the current job to the second job.

11. The method of claim 9, wherein outputting the job transition trend as the recommendation for advancing the career of the member further comprises:
identifying a career path comprising the current job, the second job, and one or more additional jobs after the second job.

12. The method of claim 9, wherein outputting the job transition trend as the recommendation for advancing the career of the member further comprises:
recommending a resource for making the transition to the second job.

13. The method of claim 12, wherein the resource comprises at least one of:
a job listing;
a recruiter;
a company.

14. A system, comprising:
one or more processors; and
memory storing instructions that, when executed by the one or more processors, cause the apparatus to:
obtain job histories for members of a social network;
aggregate a set of job transitions in the job histories to obtain a set of job transition trends associated with the members;
match a job transition trend in the set of job transition trends to member features for a member of the social network; and
output the job transition trend as a recommendation for advancing a career of the member.

15. The system of claim 14, wherein aggregating the set of job transitions in the job histories to obtain the set of job transition trends associated with the members comprises:
obtaining the set of job transitions as pairs of chronologically ordered jobs from sequences of jobs in the job histories;
aggregating the job transitions by attributes associated with the pairs of jobs; and
obtaining the set of job transition trends as a set of most frequent job transitions from the aggregated job transitions.

16. The system of claim 15, wherein the attributes comprise at least one of:
a first company associated with a first job and a second company associated with a second job;
a first industry associated with the first job and a second industry associated with the second job;
a first company size associated with the first job and a second company size associated with the second job;
a first title associated with the first job and a second title associated with the second job; and
a first seniority associated with the first job and a second seniority associated with the second job.

17. The system of claim 14, wherein matching the job transition trend to the member features for the member comprises:
matching an attribute of a current job in the member features to a first job in the job transition trend.

18. The system of claim 14, wherein outputting the job transition trend as the recommendation for advancing the career of the member comprises at least one of:
recommending a transition from a current job of the member to a second job in the job transition trend;
identifying an additional member who has made the transition from the current job to the second job;
identifying a career path comprising the current job, the second job, and one or more additional jobs after the second job; and
recommending a resource for making the transition to the second job.

19. A non-transitory computer-readable storage medium storing instructions that when executed by a computer cause the computer to perform a method, the method comprising:
obtaining job histories for members of a social network;
aggregating a set of job transitions in the job histories to obtain a set of job transition trends associated with the members;
matching a job transition trend in the set of job transition trends to member features for a member of the social network; and
outputting the job transition trend as a recommendation for advancing a career of the member.

20. The non-transitory computer-readable storage medium of claim 19, wherein aggregating the set of job transitions in the job histories to obtain the set of job transition trends associated with the members comprises:
obtaining the set of job transitions as pairs of chronologically ordered jobs from sequences of jobs in the job histories;
aggregating the job transitions by attributes associated with the pairs of jobs; and
obtaining the set of job transition trends as a set of most frequent job transitions from the aggregated job transitions.
